(19) United States
(12) Patent Application Publication
(10) Pub. No.: US 2020/0047767 A1
(43) Pub. Date: Feb. 13, 2020

(54) REMAPPING CONTROLS IN A VEHICLE

(71) Applicant: International Business Machines Corporation, Armonk, NY (US)

(72) Inventors: Gregory J. Boss, Saginaw, MI (US); Bernadette Pierson, South Hero, VT (US); Cesar Augusto Rodriguez Bravo, Alajuela (CR); Jayashree Vaidyanathan, Cincinnati, OH (US)

(21) Appl. No.: 16/058,083

(22) Filed: Aug. 8, 2018

(51) Int. Cl. B60W 50/00; G06F 3/0484; H04W 4/48; H04W 4/46; H04L 29/08

(52) U.S. Cl. CPC B60W 50/00; G06F 3/04847; B60R 16/0231; H04W 4/46; H04L 67/12; H04W 4/48

(57) ABSTRACT

A system and a method for remapping controls in a vehicle is disclosed. The system for remapping controls in a vehicle includes an input device configured to receive a data block of vehicle information. The system also includes a plurality of configurable vehicle controls situated in a vehicle, a control module configured to receive the data block from the input device to reconfigure the functionality of at least one of the plurality of configurable vehicle controls based on the data block received. The method for remapping controls in a vehicle includes the acts of receiving a data block from an operator, evaluating the data block, selecting a stored vehicle, generating a vehicle configuration based on the selected stored vehicle provided in the data block, and configuring a plurality of configurable vehicle controls according to the vehicle configuration.

### BACKGROUND

Embodiments of the present disclosure relate to vehicle controls within a vehicle, and more particularly, to configurable vehicle controls within a vehicle.

Historically, vehicles manufacturers have designed distinct layouts for the vehicle controls that are within a vehicle. As time progresses, complexity of the various layouts continues to increase due to advancements in vehicle technology. Today, not only are there basic controls to drive and operate a vehicle, but numerous controls exist for other features as well. These features may include operating a display, GPS navigation, radio, seat preferences, cruise control, driving style, paddle shifters, and many others. A person attempting to operate a vehicle must learn where the proper controls are located.

### SUMMARY

The following presents a simplified summary of the disclosure in order to provide a basic understanding to the reader. This summary is not an extensive overview of the disclosure and it does not identify key/critical elements of the invention or delineate the scope of the disclosure. Its sole purpose is to present some concepts disclosed herein in a simplified form as a prelude to the more detailed description that is presented later.

Embodiments of the invention are directed to a system that satisfies the need of analyzing and remapping the configurable vehicle controls within a vehicle to correspond with the vehicle controls of the operator's prior vehicles. A system for remapping controls in a vehicle, having features of the described embodiments, comprises of a processor, memory and an input device disposed in the vehicle that is configured to receive a data block of vehicle information data. The vehicle information data includes information that is related to a vehicle control configuration of a second vehicle. Also contained in the system is a plurality of configurable vehicle controls disposed in the vehicle. At least one of the plurality of configurable vehicle controls is configurable to control a function of the vehicle. Also, a control module disposed within the vehicle is configured to receive the data block from the input device. The control module can then analyze the received data block to reconfigure the functionality of at least one control of the plurality of the configurable vehicle controls within the vehicle.

Embodiments of the invention are also directed to a method that satisfies the need of analyzing and remapping the configurable vehicle controls within a vehicle to correspond with the vehicle controls of the operator's prior vehicles. A method for remapping controls in a vehicle, having features of the described embodiments, comprises of receiving a data block of vehicle information, where the data block includes information related to a vehicle control configuration of a plurality of stored vehicles. The method then evaluates the data block based on a plurality of factors which include determining how often the plurality of stored vehicles are operated as well as any user preferences stored within the data block. Each of the stored vehicles stored within the data block are evaluated. The method then selects a selected stored vehicle based on the evaluation for the purposes of remapping the configurable vehicle controls. The method then generates a vehicle configuration based on the selected stored vehicle. The vehicle configuration will include a layout of all configurable controls within the vehicle. The method then configures a plurality of configurable vehicle controls according to the vehicle configuration. The configuration changes at least one function of at least one configurable vehicle control to control a different function from a standard function that is assigned to the at least one control by a manufacturer of the vehicle.

It is to be understood that both the foregoing general description and the following detailed description are exemplary and explanatory and are intended to provide further explanation of embodiments of the invention as claimed.

### BRIEF DESCRIPTION OF THE DRAWINGS

These and other features, aspects, and advantages of the embodiments of the invention will become better understood with regard to the following description, appended claims, and accompanying drawings where:

FIG. 1 is a block diagram illustrating a system within a vehicle that is designed to remap the vehicle controls according to embodiments.

FIG. 2 is a flow diagram illustrating the process for remapping the vehicle controls within a vehicle according to embodiments.

FIG. 3 is a block diagram illustrating a computing system according to one embodiment.

FIG. 4 depicts a cloud computing environment according to an embodiment of the present invention.

FIG. 5 depicts abstraction model layers according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention. Like reference numerals are used to designate like parts in the accompanying drawings.

### DETAILED DESCRIPTION

In the Summary above and in the Detailed Description, and the claims below, and in the accompanying drawings, reference is made to particular features (including method steps) of the invention. It is to be understood that the disclosure of the disclosure in this specification includes all possible combinations of such particular features. For example, where a particular feature is disclosed in the context of a particular aspect or embodiment of the invention, or a particular claim, that feature can also be used, to the extent possible in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

The terms “device” and “module” are only used to describe components as an aid in understanding the components. Thus, the terms “device” and “module” should not be considered as having specific meanings or roles. Accordingly, the terms “device” and “module” may be used interchangeably.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

All the features disclosed in the specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

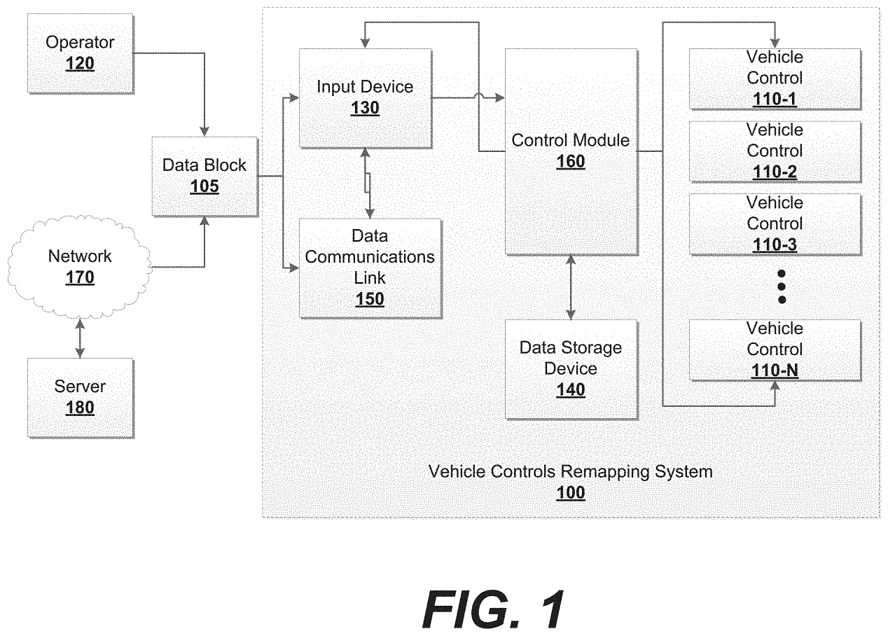

FIG. 1 is a block diagram illustrating the components of a vehicle controls remapping system 100 according to illustrative embodiments. The remapping system 100 includes a plurality of configurable vehicle controls 110-1, 110-2, 110-3 . . . 110-N (collectively vehicle controls 110), a control module 160, an input device 130, and a data storage device 140. These components are used to enable a system to remap various input controls that are within a vehicle.

FIG. 1 also illustrates additional components that can be included in some embodiments. These components include a data communications link 150, an operator 120, a network 170, and a server 180. These additional components also enable the remapping system 100 to remap various input controls that are within a vehicle.

The operator 120 is an entity that utilizes the remapping system 100 to remap vehicle controls 110 based on a prior vehicle configuration. In one embodiment, the operator 120 is a driver of the vehicle that desires to remap the vehicle controls 110 to a configuration that the operator 120 has previously used and is familiar with. In another embodiment, the operator 120 is a passenger within the vehicle who desires to remap a subset of the vehicle controls 110 which have been made available for passengers. For example, a driver may enter a vehicle they are unfamiliar with. Utilizing the remapping system 100, the driver may adjust the vehicle controls of the unfamiliar vehicle to match the vehicle controls of a vehicle the driver is familiar with. In another example, when a passenger that enters a vehicle, that is being utilized for transportation services such as a taxi or a ride sharing service the passenger can remap the vehicle controls 110 to suit their preference. These vehicle controls 110 can include, for example, navigation controls, heating, ventilation, and air conditioning (HVAC) controls, and audio/video (A/V) entertainment controls. However, any controls can be made available to a passenger. The operator 120 utilizes the remapping system 100 to reconfigure the vehicle controls 110 during the time they are being transported. Each subsequent passenger that utilizes the vehicle can reconfigure the controls seamlessly to their preferences as they enter and exit the vehicle. In another example, the operator 120 can be a zonal operator that can configure the vehicle controls 110 based on the location of the operator. For instance, an operator 120 that is driving the vehicle can configure the vehicle controls 110 that correspond with a driver. Similarly, another operator 120 that is a passenger in the vehicle can, in conjunction with the driving operator 120, configure the vehicle controls 110 that a typical passenger uses.

The plurality of configurable vehicle controls 110 are a variety of controls within a vehicle. The vehicle controls 110 can be disposed in a handle of steering wheel, in the handle of a vehicle door, along the steering column, on the dashboard, on and around the center console, or any other suitable location within a vehicle that is accessible to an operator 120. In some embodiments, each vehicle control 110 can be assigned a unique control that functions independently of the other controls. These functions include, for example, audio controls, (HVAC) controls, turn signals, windshield wipers, navigation controls, headlight controls, and seat position controls.

The data block 105 is a block of information that contains vehicle control information relating to the operator 120. The data block 105 is sent from the operator 120, or from an outside source, to the remapping system 100. The data block 105 includes the operator's 120 prior vehicle information, and it may also include user preferences, as well as vehicle control configurations of the prior vehicles operated. For example, the data block 105 can consist of a user profile reference number that the operator 120 created via an application associated with the remapping system 100. That user profile can contain a list of prior vehicles driven, a list of prior vehicles where the operator 120 was a passenger, prior vehicle configuration preferences, and/or customized vehicle controls configurations created by the operator 120. However, the data block 105 can be a log of information based on the vehicles that the operator 120 has driven, as well as various other types of vehicle information that the remapping system 100 is able to utilize.

The input device 130 is a component of the remapping system 100 that receives the data block 105, and then transmits the data block 105 to the control module 160. While not illustrated in FIG. 1, it should be understood that the input device 130 may include other components typically found in a vehicle such that an operator 120 can interact with the remapping system 100. For example, the input device 130 can be a navigable graphic display that displays options to the operator 120. Further, the input device 130 can automatically receive the data block 105 from the operator 120 without requiring the operator 120 to physically interact with the remapping system 100. The input device 130 is also configurable to receive the data block 105 through a data communications link 150.

The data storage device 140 is a component of the remapping system 100 that stores a variety of vehicle information for operation of the vehicle controls 110. For example, the data storage device 140 can store preset vehicle configurations for evaluation and implementation by the control module 160. In some embodiments, the data storage device 140, can store an operator's 120 prior vehicle information. In these embodiments, the information can be stored as a configuration that has been adapted to the vehicle. In some embodiments, the data storage device 140 can also store images that are to be displayed on the vehicle controls 110 that have a display. In addition, the data storage device 140 can store operator 120 preferences as to how the remapping system 100 accesses the operator's 120 data block 105 when the operator 120 utilizes the remapping system 100.

The data communications link 150 is a component of the remapping system 100 that receives a data block 105 from an outside source other than directly from the operator 120. In particular, the data communications link 150 is configured such that it can exchange the data block 105 with an outside source such as a mobile terminal of an operator 120 wirelessly. To connect wirelessly the data communication link 150 can employ wireless technology, such as, Bluetooth, Wi-Fi, GSM, CDMA, LTE, IR, and 4G networks. However, other similar methods not listed may also be utilized. The data communication method that is utilized may be selected by the operator 120 or restricted by the capabilities of the vehicle. Once an operator 120 enters a vehicle, the communication link 150 establishes a connection with a mobile device associated with the operator 120 and transmits the data block 105 of the operator to the control module 160.

The control module 160 is a component of the remapping system 100 that reconfigures the vehicle controls 110. The control module 160 is configured to receive a data block 105 from the input device 130 that coincides with a prior vehicle configuration. The control module 160 is configured to also evaluate the data block 105 and determine the appropriate vehicle configuration to be applied to the vehicle controls 110. The control module 160 is also configured to apply the appropriate vehicle configuration to vehicle controls 110 which will alter the functionality of at least one of vehicle controls 110. For example, the control module 160 receives the data block 105 from the operator 120. The control module 160 analyzes the data block and determines the most frequently operated vehicle associated with the operator 120. The control module 160 can create a vehicle controls configuration based on the information provided and apply that configuration to the vehicle controls 160. For example, in some regions of the world, such as the United States, the turn signal control is positioned on the left side of the steering column. In other regions of the world, such as Australia, the turn signal control is positioned on the right side of the column. An operator 120 can utilize the remapping system 100 to remap the turn signal control to a location they are familiar with. In one embodiment, the data block 105 that is provided to the control module 160, is a list of prior vehicles operated by the operator 120. The control module 160 is configured to evaluate the list and determines the most widely used prior vehicle from the list and retrieves the prior vehicle configuration from the data storage 140 that corresponds with the most widely used vehicle in the list that was transmitted. The control module 160 is also configured to remap the vehicle controls 110 to coincide with the retrieved configuration once the configuration is determined. In another embodiment, the communications link 150 receives a data block 105 containing a prior vehicle configuration, and sends the configuration to the control module 160 for implementation. This allows the vehicle controls remapping system 100 to seamlessly establish a layout in the vehicle for the operator 120. Due to the frequency of prior use of the prior vehicle, the operator 120 becomes familiar with the layout of the prior vehicle's controls. This familiarity is transposed onto the vehicle that is being used by the operator 120 to increase ease of use and to also increase safety because the operator 120 does not have learn where the various vehicle controls are located within the vehicle.

The network 170 is a data network system that connects with the remapping system 100. The network 170 is configured to establish a network connection with the data communications link 150 in order to facilitate the transfer of data block 105 from the server 180 to the remapping system 100. The network 170 can include cellular tower communication that couples and communicates through various networks through the Internet to establish a connection with the server 180. Other methods can include Bluetooth, RF, and providing a Wi-Fi connection to a local wireless network to establish a connection to the server 180. Vehicle electronics can communicate with outside networks via any number of communication methods and that there are numerous known techniques to achieve a network configuration.

The server 180 is a computer program or device that provides services and storage for clients. The data communications link 150 connects to the server 180 using the network 170 to establish a connection. The server 180 stores at least one data block 105 that the operator 120 remotely accesses to retrieve the data block 105.

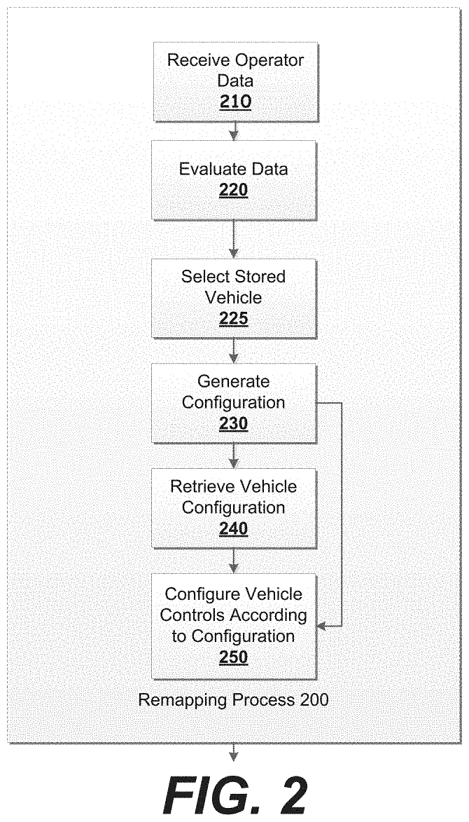

FIG. 2 is a flow diagram illustrating a remapping process 200 of selecting and implementing a vehicle configuration, according to embodiments of the present disclosure. The remapping process 200 begins by receiving data (e.g., data block 105 of FIG. 1) that is associated with an operator 120. This is illustrated at step 210. Based on the preference of the operator, the remapping system 100 can be configured to receive data in a variety of manners. For example, the operator 120 can directly input data into the remapping system 100 through an input device 130. As another example, the operator 120 can utilize a display screen within a vehicle to select a prior vehicle configuration that the operator 120 selects the current vehicle to be mapped to. However, other approaches for inputting preferences directly into a vehicle may be used. In another example, the operator 120 can transmit the data block 105 into the remapping system 100 using a data communications link 150. The transmission of the data block 105 can be seamless once the connection is established to the vehicle. In this approach, the operator 120 communicates with the data communications link 150 wirelessly. Wireless data communication can be established through various data communication methods such as Bluetooth, Wi-Fi, Near-Field Communication (NFC) connections, etc. For example, the wireless data communication can be through a mobile device that transmits the data block 105 to the remapping system 100. In another example, the connection to the data communications link 150 can be established through wired data communication that directly connects to the remapping system 100. Devices such as a mobile device or a portable computer, can pass the data block 105 through the cable and into the communications link 150. In one embodiment, the mobile device can contain an application that records the preferences of the operator 120 as well as lists of vehicles that the operator 120 has used. The application can then create a profile of the operator 120 that is sent to vehicles that utilize the remapping system 100.

Following receipt of the data block 105 by the remapping system 100, the remapping process 200 proceeds to evaluate the data block 105 information. This is illustrated at step 220. Examples of information within the data block 105 include a list of vehicles, a profile, an entire vehicle configuration, etc. In embodiments, a data block 105 may contain a list of vehicles that the operator 120 has operated. The remapping system 100 can evaluate the list of vehicles to determine what vehicle the operator 120 has utilized the most. The most utilized vehicle can be chosen because that vehicle is often the vehicle that the operator 120 is most familiar with. Vehicle usage tends to correspond to a familiarity with the various controls positioned in a vehicle. Increased familiarity with the vehicle controls 110 improves operator 120 safety and awareness. As a result, the operator 120 does not have to search for controls during operation of the vehicle. In some embodiment, the data block 105 can contain a profile that was created by the operator 120. In these embodiments, the remapping system 100 is configured to evaluate the instructions provided by the profile to determine how to proceed. For example, the profile may contain user created profiles that create a custom vehicle control configuration. The remapping system 100 is configured to evaluate custom-created profiles as well as vehicle control configurations. In other embodiments, the instructions may include a specific prior vehicle request, a custom-created configuration, metadata on the operator 120, etc.

Once the data block has been evaluated the remapping process 200 proceeds to select a stored vehicle configuration within the data block 105 that is based on the evaluation that has occurred. This is illustrated at step 225. The evaluation process is a result of weighing various factors. For example, an evaluation which factors in only selecting a stored vehicle based solely on which vehicle was most frequently operated may be used. In another example, the evaluation process proceeds using a plurality of factors such as most frequently operated vehicle as well as any user preferences that may be stored within the data block. It should be understood that a variety of factors may be selected to determine which stored vehicle to select.

After evaluating the received data block 105, the remapping process 200 proceeds to generate an appropriate vehicle configuration to be implemented in the vehicle. This is illustrated at step 230. This step compares the controls layout of the current vehicle with the selected stored vehicle selected in the remapping request of the operator 120. While most vehicles contain similar functionality, the controls in one vehicle may not necessarily be capable of being mapped onto another vehicle. This occurs as car manufacturers focus on different design characteristics which results in different vehicle layouts. The remapping system 100 determines controls that can be remapped to the vehicle, and what controls cannot be. In some embodiments, the remapping system 100 can dynamically create a configuration based on the data block 105 that was input. In other embodiments, the remapping system 100 may have a stored vehicle configuration that can be retrieved. If the data block 105 already contains a proper vehicle configuration, then the remapping process 200 proceeds with said vehicle configuration. For example, the remapping system 100 may have the proper vehicle configuration stored in memory and the operator need only select from within the vehicle. This can be accomplished by utilizing the navigational display to select the appropriate profile and the like. If the remapping system 100 generates a vehicle configuration, without the need of retrieving a stored vehicle configuration, then the process proceeds to step 250. However, if the remapping system requires the retrieval of a vehicle configuration, then the process proceeds to step 240.

If the remapping system 100 requests a vehicle configuration that is stored in the vehicle, the remapping process 200 proceeds to retrieve the vehicle configuration from a data storage device 140. This is illustrated at step 240. The retrieval process is based on the data block 105 entered and how the remapping system 100 evaluates the information. In one embodiment, a data block 105 contains a list of prior vehicles. In the current example, the remapping system 100 evaluates the list to determine the most frequently used vehicle. A vehicle configuration, based on the make, model, and year of the most frequently used vehicle, is then requested. The remapping system 100 searches and retrieves a vehicle configuration that corresponds to that request. In some embodiments, the configuration that is retrieved from the data storage device 140 can already be configured to match the current vehicle. This helps to ensures that the desired configuration can be implemented into the vehicle.

The remapping process 200 proceeds with the step of configuring the configurable vehicle controls according to the configuration that was received. This is illustrated at step 250. The vehicle controls 110 are reconfigured to match the functionality and capability of the vehicle configuration chosen by the remapping system 100. In one embodiment, at least one of the plurality of vehicle controls 110 has a display embedded on the control. In addition to the vehicle configuration, the remapping system 100 is configured to retrieve images that correspond to the functionality of each control. The images are configured with each control that has an embedded display so that the display displays an image associated with the capabilities of the control.

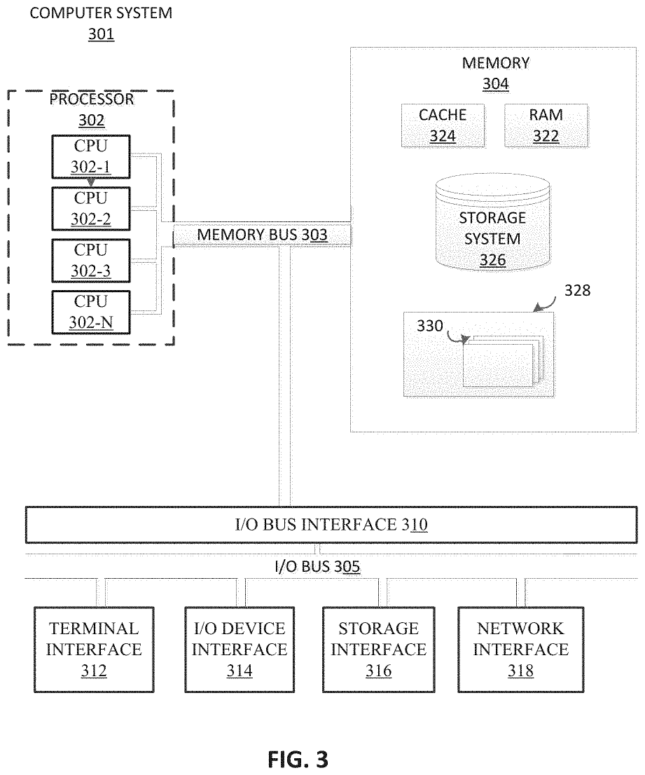

Referring now to FIG. 3, shown is a high-level block diagram of an example computer system 301 (e.g., vehicle controls remapping system 100, server 180) that may be used in implementing one or more of the methods, tools, and modules, and any related functions, described herein (e.g., using one or more processor circuits or computer processors of the computer), in accordance with embodiments of the present disclosure. In some embodiments, the major components of the computer system 301 may comprise one or more CPUs 302, a memory subsystem 304, a terminal interface 312, a storage interface 316, an I/O (Input/Output) device interface 314, and a network interface 318, all of which may be communicatively coupled, directly or indirectly, for inter-component communication via a memory bus 303, an I/O bus 308, and an I/O bus interface unit 310.

The computer system 301 may contain one or more general-purpose programmable central processing units (CPUs) 302A, 302B, 302C, and 302D, herein generically referred to as the CPU 302. In some embodiments, the computer system 301 may contain multiple processors typical of a relatively large system; however, in other embodiments the computer system 301 may alternatively be a single CPU system. Each CPU 302 may execute instructions stored in the memory subsystem 304 and may include one or more levels of on-board cache.

System memory 304 may include computer system readable media in the form of volatile memory, such as random access memory (RAM) 322 or cache memory 324. Computer system 301 may further include other removable/non-removable, volatile/non-volatile computer system storage media. By way of example only, storage system 326 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 304 can include flash memory, e.g., a flash memory stick drive or a flash drive. Memory devices can be connected to memory bus 303 by one or more data media interfaces. The memory 304 may include at least one program product having a set (e.g., at least one) of program modules that are configured to carry out the functions of various embodiments.

Although the memory bus 303 is shown in FIG. 3 as a single bus structure providing a direct communication path among the CPUs 302, the memory subsystem 304, and the I/O bus interface 310, the memory bus 303 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 310 and the I/O bus 308 are shown as single respective units, the computer system 301 may, in some embodiments, contain multiple I/O bus interface units 310, multiple I/O buses 308, or both. Further, while multiple I/O interface units are shown, which separate the I/O bus 308 from various communications paths running to the various I/O devices, in other embodiments some or all of the I/O devices may be connected directly to one or more system I/O buses.

In some embodiments, the computer system 301 may be a multi-user mainframe computer system, a single-user system, or a server computer or similar device that has little or no direct user interface, but receives requests from other computer systems (clients). Further, in some embodiments, the computer system 301 may be implemented as a desktop computer, portable computer, laptop or notebook computer, tablet computer, pocket computer, telephone, smart phone, network switches or routers, or any other appropriate type of electronic device.

It is noted that FIG. 3 is intended to depict the representative major components of an exemplary computer system 301. In some embodiments, however, individual components may have greater or lesser complexity than as represented in FIG. 3, components other than or in addition to those shown in FIG. 3 may be present, and the number, type, and configuration of such components may vary.

One or more programs/utilities 328, each having at least one set of program modules 330 may be stored in memory 304. The programs/utilities 328 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 328 and/or program modules 330 generally perform the functions or methodologies of various embodiments.

In embodiments, the program modules 330 can include a vehicle control remapping module. The vehicle control remapping module can be configured to receive a data block of vehicle information, where the data block includes information related to a vehicle control configuration of a plurality of stored vehicles. The program module then evaluates the data block based on a plurality of factors which include determining how often the plurality of stored vehicles are operated as well as any user preferences stored within the data block. Each of the stored vehicles stored within the data block are evaluated. The program module then selects a selected stored vehicle based on the evaluation for the purposes of remapping the configurable vehicle controls. The program module then generates a vehicle configuration based on the selected stored vehicle. The vehicle configuration will include a layout of all configurable controls within the vehicle. The program module then configures a plurality of configurable vehicle controls according to the vehicle configuration. The configuration changes at least one function of at least one configurable vehicle control to control a different function from a standard function that is assigned to the at least one control by a manufacturer of the vehicle.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

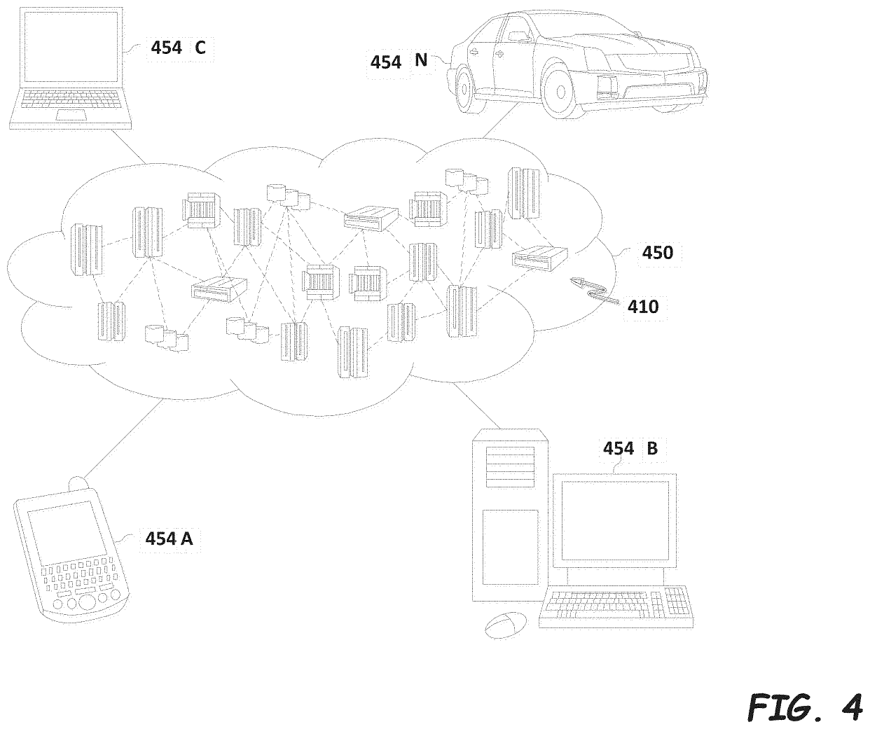

The system 100 may be employed in a cloud computing environment. FIG. 4, is a diagrammatic representation of an illustrative cloud computing environment 450 according to one embodiment. As shown, cloud computing environment 450 comprises one or more cloud computing nodes 454 with which local computing devices used by cloud consumers, such as, for example, personal digital assistant (PDA) or cellular telephone 454A, desktop computer 454B, laptop computer 454C, and/or automobile computer system 454N may communicate. Nodes 454 may communicate with one another. They may be grouped (not shown) physically or virtually, in one or more networks, such as Private, Community, Public, or Hybrid clouds as described hereinabove, or a combination thereof. This allows cloud computing environment 450 to offer infrastructure, platforms and/or software as services for which a cloud consumer does not need to maintain resources on a local computing device. It is understood that the types of computing devices 454A-N shown in FIG. 4 are intended to be illustrative only and that computing nodes 5 and cloud computing environment 450 may communicate with any type of computerized device over any type of network and/or network addressable connection (e.g., using a web browser).

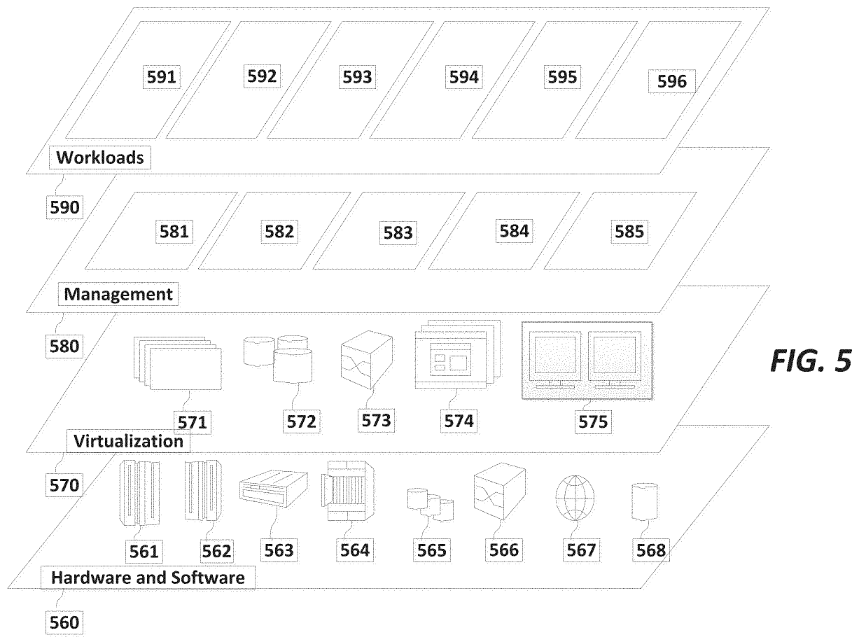

Referring now to FIG. 5, a set of functional abstraction layers provided by cloud computing environment 450 (FIG. 4) is shown. It should be understood in advance that the components, layers, and functions shown in FIG. 5 are intended to be illustrative only and embodiments of the disclosure are not limited thereto. As depicted, the following layers and corresponding functions are provided:

Hardware and software layer 560 includes hardware and software components. Examples of hardware components include: mainframes 561; RISC (Reduced Instruction Set Computer) architecture based servers 562; servers 563; blade servers 564; storage devices 565; and networks and networking components 566. In some embodiments, software components include network application server software 567 and database software 568.

Virtualization layer 570 provides an abstraction layer from which the following examples of virtual entities may be provided: virtual servers 571; virtual storage 572; virtual networks 573, including virtual private networks; virtual applications and operating systems 574; and virtual clients 575.

In one example, management layer 580 may provide the functions described below. Resource provisioning 581 provides dynamic procurement of computing resources and other resources that are utilized to perform tasks within the cloud computing environment. Metering and Pricing 582 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 583 provides access to the cloud computing environment for consumers and system administrators. Service level management 584 provides cloud computing resource allocation and management such that required service levels are met. Service Level Agreement (SLA) planning and fulfillment 585 provide pre-arrangement for, and procurement of, cloud computing resources for which a future requirement is anticipated in accordance with an SLA.

Workloads layer 590 provides examples of functionality for which the cloud computing environment may be utilized. Examples of workloads and functions which may be provided from this layer include: mapping and navigation 591; software development and lifecycle management 592; layout detection 593; data analytics processing 594; transaction processing 595; and database 596.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A system for remapping controls in a first vehicle, the system comprising:
a processor;
a memory;
an input device configured to receive a data block of vehicle information, wherein the vehicle information includes information related to a vehicle control configuration of a second vehicle and user information;
a plurality of configurable vehicle controls disposed in the first vehicle, wherein at least one of the plurality of configurable vehicle controls is configurable to control a function of the first vehicle; and
a control module disposed within the first vehicle configured to receive the data block from the input device, and to reconfigure at least one of the plurality of configurable vehicle controls according to the vehicle control configuration.

2. The system of claim 1, further comprising:
a data storage device configured to store at least one vehicle control configuration; and
wherein the control module is further configured to retrieve the at least one vehicle control configuration and reconfigure the at least one of the configurable vehicle controls based on the stored vehicle control configuration.

3. The system of claim 1, further comprising:
a display attached to the at least one of the plurality of configurable vehicle controls; and
wherein the control module is further configured to alter the display to display an image corresponding to an associated function of the configurable vehicle control.

4. The system of claim 1, further comprising:
a data communications link within the first vehicle configured to receive the data block and configured to transmit the data block to the input device.

5. The system of claim 4, wherein the data communications link establishes a wireless communications link with an outside source to receive the data block, wherein the outside source is configured to transmit the data block to the vehicle.

6. The system according to claim 4, wherein the data communications link establishes a wired communication link with an outside source to receive the data block, wherein the outside source is configured to transmit the data block to the first vehicle via a wired connection.

7. The system of claim 1, wherein the control configuration includes information related to a layout of all controls within the second vehicle.

8. A method for remapping controls in a first vehicle which comprises:
receiving a data block of vehicle information, wherein the data block includes information related to a vehicle control configuration of a plurality of stored vehicles;
evaluating the data block, based on a plurality of factors including how often the plurality of stored vehicles are operated and user preferences, of each of the plurality of stored vehicles.
selecting, based on the evaluating, a selected stored vehicle for the purposes of remapping controls;
generating a vehicle configuration based on the selected stored vehicle, wherein the vehicle configuration includes a layout of all configurable controls within the first vehicle; and
configuring a plurality of configurable vehicle controls according to the vehicle configuration, wherein this changes at least one function of at least one configurable vehicle control to control a different function from a standard function assigned to the at least one control by a manufacturer of the vehicle.

9. The method of claim 8, wherein receiving the data block further comprises:
receiving a data block from a data communications link within the first vehicle, wherein the data communications link transmits the data block to an input device.

10. The method of claim 9, wherein receiving the data block from the data communications link further comprises:
establishing a connection between the data communications link and a server over a wireless network.
receiving, at the server, the data block.

11. The method of claim 9, wherein receiving the data block from the data communications link further comprises:
establishing a connection between the data communications link and a device over a wired communications link.
receiving, at the device, the data block.

12. The method of claim 8, wherein the generating a vehicle configuration comprises:
retrieving a stored vehicle configuration from a data storage device based on the selected stored vehicle, wherein the stored vehicle configuration includes a layout of all configurable controls within the selected stored vehicle.

13. The method of claim 8, further comprising:
displaying an image on a display that is attached to the at least one of the configurable vehicle controls, wherein the image corresponds to the functionality of the vehicle control.

14. A computer readable storage medium having computer readable instructions that when executed by a computer having at least one processor causes the computer to:
receive a data block of vehicle information data, wherein the data block includes information related to a vehicle control configuration of a plurality of stored vehicles;
evaluate the data block, based on a plurality of factors including how often the plurality of stored vehicles are operated and user preferences, of each of the plurality of stored vehicles.
select, based on the evaluating, a selected stored vehicle for the purposes of remapping controls;
generate a vehicle configuration based on the selected stored vehicle, wherein the vehicle configuration includes a layout of all configurable controls within the selected stored vehicle; and
configure a plurality of configurable vehicle controls according to the vehicle configuration, wherein this changes at least one function of at least one control to control a different function from a standard function assigned to the at least one control by a manufacturer of the vehicle.

15. The computer readable storage medium of claim 14, wherein the generate a vehicle configuration comprises:
retrieve a stored vehicle configuration from a data storage device based on the selected stored vehicle, wherein the stored vehicle configuration includes a layout of all configurable controls within the selected stored vehicle.

16. The computer readable storage medium of claim 14, further comprising:
display an image on a display that is attached to at least one of the configurable vehicle control, wherein the image corresponds to the functionality of the vehicle control.

17. The computer readable storage medium of claim 14, wherein receive the data block further comprises:
receive a data block from a data communications link.

18. The computer readable storage medium of claim 17, wherein receive the data block from the data communications link further comprises:
establish a connection between the data communications link and a server over a wireless network.
receive, at the server, the data block.

19. The computer readable storage medium of claim 17, wherein receive the data block from the data communications link further comprises:
establish a connection between the data communications link and a device over a wired communications link.
receive, at the device, the data block.

20. The computer readable storage medium of claim 17, wherein receive the data block from the data communications link further comprises:
establish a connection between the data communications link and a mobile device over a wireless network; and
receive, from the mobile device, the data block.
